(19) United States
(12) Patent Application Publication
(10) Pub. No.: US 2020/0242512 A1
(43) Pub. Date: Jul. 30, 2020

(54) INFORMATION PROCESSING METHOD AND INFORMATION PROCESSING DEVICE

(71) Applicant: FUJITSU LIMITED, Kawasaki-shi (JP)

(72) Inventors: Chaoliang ZHONG, Beijing (CN); Jun SUN, Beijing (CN)

(73) Assignee: FUJITSU LIMITED, Kawasaki-shi (JP)

(21) Appl. No.: 16/737,949

(22) Filed: Jan. 9, 2020

(30) Foreign Application Priority Data
Jan. 24, 2019 (CN) 201910066435.9

(51) Int. Cl. G06N 20/00; G06N 5/04; B25J 9/16

(52) U.S. Cl. CPC G06N 20/00; B25J 9/163; G06N 5/043

(57) ABSTRACT

An information processing method comprises: generating an action sequence pair of a first action sequence of a first agent and a second action sequence of a second agent, the first and second action sequences performing an identical task; training a mapping model using the generated action sequence pair such that it is capable of generating an action sequence of the second agent according to an action sequence of the first agent; training a judgment model using the first action sequence of the first agent such that it is capable of judging whether a current action of an action sequence of the first agent is a last action of the action sequence; and constructing a mapping library using the trained mapping model and the trained judgment model, wherein the mapping library comprises a mapping from observation information of the second agent to an action sequence of the second agent.

### CROSS-REFERENCE TO RELATED APPLICATIONS

This application claims the priority benefit of Chinese Patent Application No. 201910066435.9, filed on Jan. 24, 2019 in the China National Intellectual Property Administration, the disclosure of which is incorporated herein in its entirety by reference.

### FIELD OF THE INVENTION

The present invention relates generally to the technical field of transfer learning of an agent, and more particularly, to an information processing method and information processing device which transfer processing knowledge of a first agent with respect to a task to a second agent having a different action space from that of the first agent.

### BACKGROUND

At present, intelligent machines as an example of agents have been widely applied in fields such as industrial manufacture, surgery medical treatment and the like. An intelligent machine generally has a multi-joint manipulator or a multi-degree-of-freedom action device, and is capable of intelligently performing a series of actions according to observation information depending on its own power and control ability so as to perform a predetermined task.

Training an intelligent machine such that it is capable of autonomously performing a predetermined task according to observation information generally needs a large number of training samples and consumes much time. Therefore, it would be very advantageous if it is possible to transfer processing knowledge of a trained intelligent machine to an untrained intelligent machine such that the untrained intelligent machine has identical processing knowledge.

However, action spaces of intelligent machines may be different even if the intelligent machines have identical or similar processing abilities. For example, for mechanical arms, even if their actions can reach identical ranges, their action spaces are still different since their degrees of freedom (DoFs) are different. Further, even if for mechanical arms having identical DoFs, action spaces may still be different for reasons such as different sizes of connecting rods, different kinds of joints and the like. Herein, components such as connecting rods, joints and the like of mechanical arms which take part in actions of the mechanical arms are uniformly referred to as an execution mechanism.

Specifically, for example, for a 4 DoF mechanical arm, its action space may be a space formed by vectors composed of states of 4 joints: (State 1, State 2, State 3, State 4), and for a 6 DoF mechanical arm, its action space may be a space formed by vectors composed of states of 6 joints: (State 1, State 2, State 3, State 4, State 5, State 6), wherein a state of each joint may be represented by, for example, an angle.

For the above-mentioned example, a trained 4 DoF mechanical arm is capable of autonomously performing a predetermined task, whereas it is difficult to transfer current processing knowledge of the 4 DoF mechanical arm to the 6 DoF mechanical arm. In case of re-training the 6 DoF mechanical arm to perform an identical task, it is needed to consume much time.

Therefore, a technique capable of transferring processing knowledge of a trained agent with respect to a task to an untrained agent having a different action space is needed.

### SUMMARY OF THE INVENTION

The present disclosure proposes an information processing method and information processing device capable of transferring processing knowledge of a trained agent with respect to a task to an untrained agent having a different action space, thereby simplifying a training process of the untrained agent having a different action space, so as to lower a training cost and improve training efficiency.

A brief summary of the present disclosure will be given below to provide a basic understanding of some aspects of the present disclosure. It should be understood that the summary is not an exhaustive summary of the present disclosure. It does not intend to define a key or important part of the present disclosure, nor does it intend to limit the scope of the present disclosure. The object of the summary is only to briefly present some concepts, which serves as a preamble of the detailed description that follows.

One of the objects of the present disclosure lies in providing an information processing method and information processing device capable of transferring processing knowledge of a trained agent with respect to a task to an untrained agent having a different action space. By the information processing method and information processing device according to the present disclosure, it is possible to simplify a training process of the untrained agent having a different action space, so as to lower a training cost and improve training efficiency.

To achieve the object of the present disclosure, according to an aspect of the present disclosure, there is provided an information processing method for transferring processing knowledge of a first agent to a second agent, wherein the first agent is capable of performing a corresponding action sequence according to observation information of the first agent, the information processing method comprising steps of: generating an action sequence pair of a first action sequence of the first agent and a second action sequence of the second agent, wherein the first action sequence and the second action sequence perform an identical task; training a mapping model using the generated action sequence pair, wherein the mapping model is capable of generating an action sequence of the second agent according to an action sequence of the first agent; training a judgment model using the first action sequence of the first agent, wherein the judgment model is capable of judging whether a current action of an action sequence of the first agent is a last action of the action sequence; and constructing a mapping library using the trained mapping model and the trained judgment model, wherein the mapping library comprises a mapping from observation information of the second agent to an action sequence of the second agent.

According to another aspect of the present disclosure, there is provided an information processing device for transferring processing knowledge of a first agent to a second agent, wherein the first agent is capable of performing a corresponding action sequence according to observation information of the first agent, the information processing device comprising: a generating unit configured to generate an action sequence pair of a first action sequence of the first agent and a second action sequence of the second agent, wherein the first action sequence and the second action sequence perform an identical task; a first training unit configured to train a mapping model using the generated action sequence pair, wherein the mapping model is capable of generating an action sequence of the second agent according to an action sequence of the first agent; a second training unit configured to train a judgment model using the first action sequence of the first agent, wherein the judgment model is capable of judging whether a current action of an action sequence of the first agent is a last action of the action sequence; and a constructing unit configured to construct a mapping library using the trained mapping model and the trained judgment model, wherein the mapping library comprises a mapping from observation information of the second agent to an action sequence of the second agent.

According to another aspect of the present disclosure, there is provided a computer program capable of implementing the above-mentioned information processing method. Further, there is also provided a computer program product in at least computer readable medium form, which has recorded thereon a computer program code for implementing the above-mentioned information processing method.

The technique according to the present disclosure is capable of transferring processing knowledge of a trained agent with respect to a task to an untrained agent having a different action space, thereby simplifying a training process of the untrained agent having a different action space, so as to lower a training cost and improve training efficiency.

### BRIEF DESCRIPTION OF THE DRAWINGS

The above and other objects, features and advantages of the present disclosure would be more easily understood with reference to the following description of embodiments of the present disclosure combined with the appended drawings. In the appended drawings:

FIG. 1A and FIG. 1B are schematic views showing a 4 DoF mechanical arm and a 6 DoF mechanical arm as examples of agents and their task spaces, respectively;

FIG. 2 shows a flowchart of an information processing method for transferring processing knowledge of a first agent to a second agent according to an embodiment of the present disclosure;

FIG. 3 shows a flowchart of exemplary processing of training a mapping model using an action sequence pair according to an embodiment of the present disclosure;

FIG. 4 shows a schematic view of exemplary processing of training a mapping model using an action sequence pair according to an embodiment of the present disclosure;

FIG. 5 shows a schematic view of exemplary processing of training a judgment model using a first action sequence;

FIG. 6 shows a flowchart of exemplary processing of constructing a mapping library using trained mapping model and judgment model according to an embodiment of the present disclosure;

FIG. 7 shows a schematic view of exemplary processing of constructing a mapping library using trained mapping model and judgment model according to an embodiment of the present disclosure;

FIG. 8 shows a structural block diagram of an information processing device according to an embodiment of the present disclosure; and

FIG. 9 shows a structure diagram of a general-purpose machine that can be used to realize the information processing method and information processing device according to the embodiments of the present disclosure.

### DETAILED DESCRIPTION OF THE INVENTION

Hereinafter, some embodiments of the present disclosure will be described in detail combined with the appended illustrative figures. In denoting elements in the figures with reference signs, although identical elements are shown in different figures, identical elements will be denoted by identical reference signs. Further, in the following description of the present disclosure, detailed description of known functions and configurations incorporated herein will be omitted while possibly making the subject matter of the present disclosure unclear.

The terms used herein are used only for the purpose of describing specific embodiments, but are not intended to limit the present disclosure. The singular forms used herein are intended to also include plural forms, unless otherwise indicated in the context. It will also be understood that, the terms “comprise”, “include” and “have” used in the specification are intended to specifically indicate presence of features, entities, operations and/or components as stated, but do not preclude presence or addition of one or more other features, entities, operations and/or components.

All the terms including technical terms and scientific terms used herein have same meanings as they are generally understood by those skilled in the field to which the concept of the present invention pertains, unless otherwise defined. It will be further understood that, terms such as those defined in a general dictionary should be construed as having meanings consistent with those in the context of the relevant field and, unless explicitly defined herein, should not be interpreted with ideal or quite formal meanings.

In the description that follows, many specific details are stated to provide comprehensive understanding to the present disclosure. The present disclosure could be implemented without some or all of these specific details. In other examples, to avoid the present disclosure from being obscured due to unnecessary details, only those components closely related to the solution according to the present disclosure are shown in the drawings, while omitting other details not closely related to the present disclosure.

Hereinafter, an information processing technique for transferring processing knowledge of a trained agent with respect to a task to an untrained agent having a different action space according to the present disclosure will be described in detail with reference to the drawings.

The core concept of the information processing technique according to the present disclosure lies in establishing a mapping relationship between action spaces of agents having different action spaces. Specifically, it is assumed that a first agent is a trained agent capable of performing a corresponding action sequence according to observation information thereof, and that a second agent is an untrained agent having a different action space from the first agent. The technique according to the present disclosure needs to train a mapping model, for converting a first action sequence of the first agent to a second action sequence of the second agent, wherein the first action sequence and the second action sequence are capable of performing an identical task. To train the mapping model, it is needed to construct a training sample set of the mapping model, the training sample set being composed of action sequence pairs of first action sequences of the first agent and second action sequences of the second agent. Further, since no mark representing an end of an action sequence exists in the action sequence, it is also needed to train a judgment model, for judging an end of an action sequence. In this regard, it is possible to use the first action sequence of the first agent as a training sample set of the judgment model to train the judgment model. Finally, a mapping library is constructed using the trained mapping model and judgment model, such that the second agent can spontaneously perform a corresponding action sequence according to observation information thereof based on the mapping library, so as to perform an identical task to the first agent.

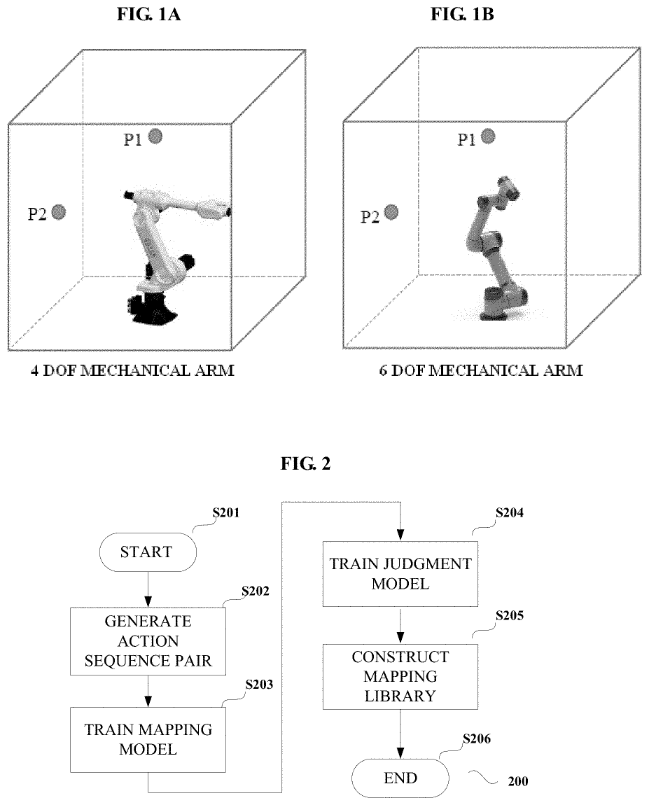

Next, an information processing method for transferring processing knowledge of a first agent to a second agent according to an embodiment of the present disclosure will be described with reference to FIG. 1 to FIG. 6.

Examples of agents may include mechanical arms, robots, etc. Different agents may have different action spaces which are caused by different degrees of freedom of actions, different sizes of connecting rods and different kinds of j oints.

As specific examples of agents, FIG. 1A and FIG. 1B are schematic views showing a 4 DoF mechanical arm and a 6 DoF mechanical arm as examples of agents and their task spaces, respectively. In an embodiment of the present disclosure, a task may be defined as a pair containing a start position and an end position. Specifically, as shown in FIG. 1, the position referred to herein may be represented by coordinates within a range that can be reached by a tail end of an execution mechanism of a mechanical arm in a three-dimensional space. For example, taking a pedestal of the mechanism arm as an origin, the following task may be defined:

Task<P1, P2>=<(0.2, 0.4, 0.3), (0.1, 0.2, 0.4)>

The task means moving the tail end of the execution mechanism of the mechanical arm from coordinates P1(0.2, 0.4, 0.3) (the start position) to coordinates P2(0.1, 0.2, 0.4) (the end position). Herein, it is possible to take any length dimension as a unit. Herein, a set of pairs composed of coordinates representing start positions and end positions of all tasks is defined as a task space. The task space is a two-dimensional space composed of start positions and end positions.

Herein, the 4 DoF mechanical arm is a specific example of the trained first agent, which is hereinafter also referred to as a source mechanical arm, and the 6 DoF mechanical arm is a specific example of the untrained second agent, which is hereinafter also referred to as a target mechanical arm. The first agent and the second agent can have identical task spaces.

FIG. 2 shows a flowchart of an information processing method 200 for transferring processing knowledge of a first agent to a second agent according to an embodiment of the present disclosure. Herein, the first agent is capable of performing a corresponding action sequence according to observation information thereof. The information processing method 200 according to the embodiment of the present disclosure starts at step S201. In step S202, an action sequence pair of a first action sequence of the first agent and a second action sequence of the second agent is generated, wherein the first action sequence and the second action sequence perform an identical task. Next, in step S203, a mapping model is trained using the generated action sequence pair, wherein the mapping model is capable of generating an action sequence of the second agent according to an action sequence of the first agent. Subsequently, in step S204, a judgment model is trained using the first action sequence of the first agent, wherein the judgment model is capable of judging whether a current action of an action sequence of the first agent is a last action of the action sequence. Subsequently, in step S205, a mapping library is constructed using the trained mapping model and the trained judgment model, wherein the mapping library comprises a mapping from observation information of the second agent to an action sequence of the second agent. Finally, the information processing method 200 ends at step S206.

Exemplary embodiments of the respective steps S202 to S205 of the information processing method 200 according to the embodiment of the present disclosure will be described in detail using the 4 DoF mechanism arm and the 6 DoF mechanism arm as the specific examples of the first agent and the second agent respectively as shown in FIG. 1.

In step S202, an action sequence pair of a first action sequence of the first agent and a second action sequence of the second agent is generated, wherein the first action sequence and the second action sequence perform an identical task. As stated above, to train the mapping model, it is needed to construct an action sequence pair set as a training sample set of the mapping model. The action sequence pair is a pair composed of the first action sequence of the first agent and the second action sequence of the second agent, wherein the first action sequence and the second action sequence perform an identical task. Further, to facilitate processing, the paired first action sequence and second action sequence are represented by grammars in the same form. Particularly, the paired first action sequence and second action sequence can have different lengths, and thus actions in the two action sequences may not have a one-to-one correspondence.

To construct an action sequence pair set as a training sample set of the mapping model, it is needed to randomly perform sampling on tasks in a task space. According to the embodiment of the present disclosure, it is possible to construct different action sequence pairs by using different tasks.

Specifically, for each task sampled from the task space, a start position and an end position of the task are obtained. Subsequently, the start position and the end position are inputted to an action planning tool, which is capable of automatically planning a corresponding action trajectory according to the start position and the end position of the task, and a sequence formed by each action in the action trajectory is an action sequence. Herein, the action planning tool can use an action planning tool known in the art, for example Movelt, and thus no further detailed description will be made.

For the example as shown in FIG. 1, the action sequence of the 4 DoF source mechanical arm as the example of the first agent is a first action sequence, also referred to as a source action sequence, and the action sequence of the 6 DoF target mechanical arm as the example of the second agent is a second action sequence, also referred to as a target action sequence.

For each task adopted, the task is performed by the first agent and the second agent, respectively, to obtain a first action sequence and a second action sequence, respectively, so as to form an action sequence pair. According to the embodiment of the present disclosure, action sequence end marks EOSs are added at the ends of the obtained first action sequence and second action sequence.

For example, for a task<(0.2, 0.4, 0.3), (0.1, 0.2, 0.4)> sampled from the task space, the task is performed using the 4 DoF source mechanical arm as the example of the first agent and the 6 DoF target mechanical arm as the example of the second agent, respectively.

Herein, it is assumed that states of the respective joints of the mechanism arm are represented by angles, with precision of 1°. A maximum activity stroke of the respective joints of each action is 2°.

After the 4 DoF source mechanical arm performs the task, it is possible to generate a source action sequence, i.e., the first action sequence S=[a11, a12, a13]. Further, after the 6 DoF target mechanical arm performs the task, it is possible to generate a target action sequence, i.e., the second action sequence T=[a21, a22, a23, a24].

Wherein values of the respective actions in the source action sequence S are as follows:

a11=(55°, 62°, 71°, 43°);

a12=(53°, 64°, 69°, 42°);

a13=(51°, 66°, 67°, 41°).

Values of the respective actions in the target action sequence T are as follows:

a21=(42°, 11°, 27°, 78°, 52°, 30°);

a22=(40°, 13°, 28°, 79°, 54°, 32°);

a23=(38°, 15°, 30°, 80°, 56°, 34°);

a24=(36°, 17°, 32°, 80°, 58°, 35°).

For the source action sequence S, the action a11 is an action performed by the source mechanical arm at the start position of the task, and then the actions a12, a13 are sequentially performed. Upon completion of the performing of the action a13 by the 4 DoF source mechanical arm, the tail end of the execution mechanism of the 4 DoF source mechanical arm reaches an end position, thereby completing the task. Specifically, taking the action a11 as an example, (55°, 62°, 71°, 43°) are sequentially the joint states of the 4 joints of the 4 DoF source mechanical arm. When the 4 DoF source mechanical arm performs the action a12, the angle of the first joint is reduced by 2°, the angle of the second joint is increased by 2°, the angle of the third joint is reduced by 2°, and the angle of the fourth joint is reduced by 1°.

The respective actions in the target action sequence of the 6 DoF target mechanical arm are similar hereto, but the number of the joints of the 6 DoF target mechanical arm is 6.

Subsequently, S and T are combined into an action sequence pair <S, T>, which is then added to an action sequence pair set C. C={<S, T>}, wherein S is a first action sequence generated after the source mechanical arm performs a sampling task, and T is a second action sequence generated after the target mechanical arm performs the same sampling task.

By sampling different tasks from the task space and respectively causing the first agent and the second agent to perform the tasks, it is possible to obtain action sequence pairs to form an action sequence pair set as a training sample set of the mapping model. A number of the action sequence pairs forming the training sample set of the mapping model can be arbitrary. A relatively more number of the action sequence pairs can obtain a better training effect on the mapping model, but also correspondingly causes a higher training cost. Therefore, it is possible to determine, according to specific applications, the number of the action sequence pairs needed to be obtained.

Subsequently, in step S203, a mapping model is trained using the generated action sequence pair, and the object of training lies in enabling the mapping model to generate an action sequence of the second agent according to an action sequence of the first agent.

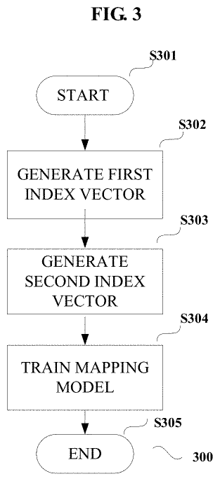

FIG. 3 shows a flowchart of exemplary processing 300 of training a mapping model using an action sequence pair according to an embodiment of the present disclosure. The processing 300 starts at step S301.

Subsequently, in step S302, a first index of an action of the first agent is set, to represent the first action sequence of the first agent by a first index vector representing the first index. Further, in step S303, a second index of an action of the second agent is set, to represent the second action sequence of the second agent by a second index vector representing the second index. The first index vector and the second index vector are length-fixed vectors with identical lengths which respectively represent actions of the first agent and actions of the second agent. It should be noted that, an execution order of step S302 and Step S303 can be arbitrary, and it is possible to first perform step S302 and subsequently perform step S303, or to first perform step S303 and subsequently perform step S302, or to concurrently perform steps S302 and S303.

According to the embodiment of the present disclosure, to train the mapping model, based on the constructed action sequence pair set, with respect to each action in a source action sequence (i.e., first action sequence) in each sequence pair, a first index is set therefor in a dictionary, so as to construct a source action dictionary. Similarly, with respect to each action in a target action sequence (i.e., second action sequence) in each sequence pair, an index is set, so as to construct a target action dictionary.

With respect to the first agent, it is possible to set a corresponding first index with respect to each action in all the first action sequences obtained. For example, for the first action sequence S=[a11, a12, a13] of the 4 DoF source mechanical arm as the example of the first agent as stated above, the following first indices can be set:

(55°, 62°, 71°, 43°)→1

(53°, 64°, 69°, 42°)→2

(51°, 66°, 67°, 41°)→3

. . .

Further, with respect to the second agent, it is possible to set a corresponding second index with respect to each action in all the second action sequences obtained. For example, for the second action sequence T=[a21, a22, a23, a24] of the 6 DoF target mechanical arm as the example of the second agent as stated above, the following second indices can be set:

(42°, 11°, 27°, 78°, 52°, 30°)→1

(40°, 13°, 28°, 79°, 54°, 32°)→2

(38°, 15°, 30°, 80°, 56°, 34°)→3

(36°, 17°, 32°, 80°, 58°, 35°)→4

. . .

Herein, the set first index and second index are each an integer, which is inconvenient for training the mapping model, and thus it is possible to convert the first index and the second index as integers to vectors. The simplest method in the art is one-hot encoding technique, that is, an index vector dimension is equal to a number of all indices, i.e., identical to a size of a dictionary, wherein values of elements to which the corresponding indices correspond in the index vectors are 1, and values of all the other elements are 0.

However, the one-hot encoding technique possibly will occupy massive storage space for storage. Therefore, preferably, it is possible to employ word embedding technique to convert the first index and the second index to length-fixed vectors with each dimension value being a real number. Herein, the word embedding technique can use the word embedding technique known in the art, for example Word2Vec, and thus no further detailed description will be made.

For example, for a first index of each action of the 4 DoF source mechanical arm as the example of the first agent as stated above, it is possible to convert it to the following first index vectors as 4-dimensional real vectors.

1→(0.6897, 0.314, 0.4597, 0.6484)

2→(0.6572, 0.7666, 0.8468, 0.3075)

3→(0.1761, 0.0336, 0.1119, 0.7791)

. . .

Further, for example for a second index of each action of the 6 DoF target mechanical arm as the example of the second agent as stated above, it is possible to convert it to the following second index vectors as 4-dimensional real vectors.

1→(0.494, 0.6018, 0.2934, 0.0067)

2→(0.0688, 0.8565, 0.9919, 0.4498)

3→(0.647, 0.0328, 0.7988, 0.7429)

4→(0.1579, 0.2932, 0.9996, 0.0464)

. . .

Through the above-mentioned processing, the first action sequence may be represented by a first index vector, and the second action sequence may be represented by a second index vector.

Next, in step S304, the mapping model is trained using the first index vector and the second index vector.

According to the embodiment of the present disclosure, the mapping model can comprise an encoding unit and a decoding unit, wherein the encoding unit can encode an action sequence of the first agent to a length-fixed vector, and the decoding unit can decode the length-fixed vector to an action sequence of the second agent.

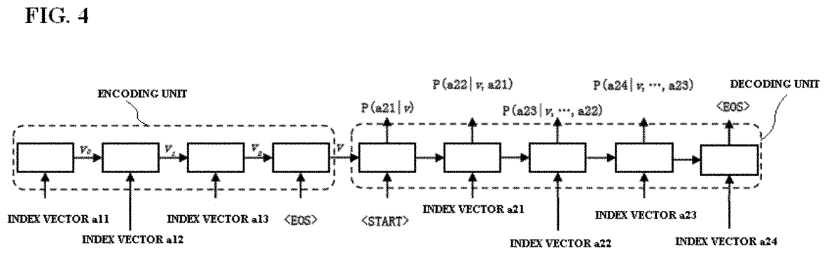

FIG. 4 shows a schematic view of exemplary processing of training a mapping model using an action sequence pair according to an embodiment of the present disclosure.

As shown in FIG. 4, the mapping model comprises two parts, i.e., an encoding unit and a decoding unit. According to the embodiment of the present disclosure, the encoding unit and the decoding unit each can be realized by a recurrent neural network (RNN) model. The recurrent neural network is an artificial neural network which has a tree-like hierarchical structure and in which network nodes perform recursion on input information in their connection order, and is one of deep learning algorithms.

Further, according to the embodiment of the present disclosure, it is also possible to use a long-short term memory (LSTM) model or a gated recurrent unit (GRU) model as an improved recurrent neural network to realize the encoding unit and the decoding unit which form the mapping model.

Since the RNN model, the LSTM model and the GRU model are known to those skilled in the art, the present disclosure only describes applications thereof in the embodiment of the present disclosure without making detailed description of principles thereof, for the sake of conciseness.

As shown in FIG. 4, for example, for the first action sequence S=[a11, a12, a13], a first index vector corresponding to the action a11, for example (0.6897, 0.314, 0.4597, 0.6484), is inputted to the encoding unit at time t₀, to obtain an implicit state v₀ at the time t₀. Subsequently, a first index vector corresponding to the action a12, for example (0.6572, 0.7666, 0.8468, 0.3075), and the implicit state v₀ at the time t₀ are inputted to the decoding unit at time t₁, to obtain an implicit state v₁ at the time t₁. Subsequently, a first index vector corresponding to the action a13, for example (0.1761, 0.0336, 0.1119, 0.7791), and the implicit state v₁ at the time t₁ are inputted to the decoding unit at time t₂, to obtain an implicit state v₂ at the time t₂. Subsequently, an end mark <EOS> vector representing an end of the first action sequence and the implicit state v₂ at the time t₂ are inputted to the decoding unit at the time t₂, and at this time the encoding unit finishes the operation, and outputs the last implicit state v.

Next, for the second action sequence T=[a21, a22, a23, a24], the implicit state v outputted by the encoding unit and a start mark <START> vector representing a start of decoding are inputted to the encoding unit at the time t₀, to obtain a probability distribution on the target action dictionary. According to the probability distribution and the second index vector of the action a21, it is possible to obtain a probability P(a21|v) of the action a21 to be predicted. By this analogy, it is possible to obtain probabilities P(a22|v,a21), P(a23|v, . . . , a22), P(a24|v, . . . , a23) of each of the remaining actions a22, a23, a23 in the second action sequence T to be correctly predicted. Subsequently, a probability corresponding to each action to be correctly predicted is multiplied, so as to obtain a probability of the second action sequence to be correctly predicted. Further, similarly to the encoding unit, in each time step, only an implicit state is transferred to decoding processing in a next time step.

The realization of the decoding unit and the encoding unit will be simply explained by taking the LSTM model as an example below. The realization manner of employing other RNN models such as the GRU model is similar hereto, and thus no further description will be made herein.

The LSTM model is capable of learning a dependency in a long time range by its memory unit, and it generally comprises four units, i.e., an input gate iₜ, an output gate oₜ, a forget gate fₜ, and a storage state Cₜ, wherein t represents a current time step. The storage state Cₜ influences current states of other units according to a state of a previous time step. The forget gate fₜ may be used for determining which information should be abandoned. The above process may be represented by the following equations

iₜ=σ(W_{(i,x)}xₜ+W_{(i,h)}hₜ₋₁+bᵢ)

fₜ=σ(w_{(f,x)}xₜ+W_{(f,h)}hₜ₋₁+b_{f})

gₜ=tanh(W_{(g,x)}xₜ+W_{(g,h)}hₜ₋₁+b_{g})

cₜ=iₜ⊙gₜ+fₜ⊙cₜ₋₁

σₜ=σ(W_{(o,x)}xₜ+W_{(o,h)}hₜ₋₁+bₒ)

hₜ=oₜ⊙tanh(cₜ)

Where σ is a sigmoid function, ⊙ represents sequentially multiplying vector elements, xₜ represents an input of the current time step t, hₜ represents an intermediate state of the current time step t, and oₜ represents an output of the current time step t. Connection weight matrixes W_{(i,x)}, W_{(f,x)}, W_{(g,x)}, W_{(o,x)} and biasing vectors bᵢ, b_{f}, b_{C}, bₒ are parameters to be trained.

When the above LSTM model is used to realize the encoding unit, a first index vector corresponding to each action in the first action sequence is inputted as xₜ to the input gate iₜ, and a hidden state in a previous time step is also inputted as hₜ₋₁ to the input gate iₜ. When the above LSTM model is used to realize the encoding unit, use of the output oₜ of the current time step is abandoned, and only the intermediate state hₜ of the current time step t is used as a hidden state in a next time step.

Further, when the above LSTM model is used to realize the decoding unit, a second index vector corresponding to each action in the second action sequence is inputted as xₜ to the input gate iₜ, and a hidden state in a previous time step is also inputted as hₜ₋₁ to the input gate iₜ. However, differing from the encoding unit, when the above LSTM model is used to realize the decoding unit, the output oₜ of the current time step is outputted as a probability of a corresponding action to be correctly predicted.

For the above mapping model, the object of training lies in maximizing a probability of the second action sequence T to which the first action sequence S corresponds (wherein S and T form an action sequence pair) to be correctly predicted, and this may be represented by the following target function

$$\frac{1}{\vert S \vert} {\sum }_{< τ , S > ∈ C} log p ( T \vert S )$$

The target function represents adding and then averaging an obtained probability of each action sequence pair <S, T> in the training sample set C of the mapping model to be correctly predicted, and an optimization target is maximizing the average probability to be correctly predicted. Through a plurality of times of iterations, it is possible to obtain the respective parameters of the mapping model, wherein a number of the times of the iterations may either be determined according to a convergence situation or be artificially set. For example, in a case where the LSTM model is used to realize the encoding unit and the decoding unit of the mapping model, it is possible to obtain, through training (iterations), numerical values of the connection weight matrixes W_{(i,x)}, W_{(f,x)}, W_{(g,x)}, W_{(o,x)} and the biasing vectors bᵢ, b_{f}, b_{g}, bₒ of the LSTM model which realizes the encoding unit and the decoding unit.

Based on the above-mentioned example extended to universal situations, it is assumed that the given first action sequence S=(x₁, . . . , x_{T}), with the second action sequence corresponding thereto being T=(y₁, . . . , y_{T′}), wherein T is a length of the first action sequence, T′ is a length of the second action sequence, T and T′ may be different, and at the decoding unit, log p(T|S) in the above equation may be represented as follows:

log p(T|S)=p(y₁, . . . ,y_{T′}|x₁, . . . ,x_{T})=Πₜ₌₁^{T′}p(yₜ|v,y₁, . . . ,yₜ₋₁)

Wherein p(yₜ|v,y₁, . . . , yₜ₋₁) represents a probability of an action yₜ in the second action sequence to be correctly predicted based on previous actions y₁ to yₜ₋₁ thereof and the implicit state v outputted from the encoding unit.

It should be noted that, in the training process of the mapping model, each action sequence needs an addition of an end mark <EOS> at an end, which enables the mapping model to be trained with respect to all possible action sequence lengths. In other words, for example, with respect to the above-mentioned example, an input with respect to the encoding unit is [a11, a12, a13, <EOS>], and the decoding unit calculates a probability to be correctly predicted with respect to [a21, a22, a23, a24, <EOS>].

Through the above-mentioned training, the trained mapping model is capable of mapping an action sequence of the first agent to an action sequence of the second agent.

Further, according to the embodiment of the present disclosure, for the encoding unit and the decoding unit which form the mapping model, it is possible to use different RNN models to realize the encoding unit and the decoding unit, which can perform training on the encoding unit and the decoding unit simultaneously with respect to a plurality of first agents and second agents. Specifically speaking, the trained encoding unit and decoding unit can be used separately and in combination.

Further, according to the embodiment of the present disclosure, the encoding unit can encode an inverse sequence of an action sequence of the first agent to a length-fixed vector, and the decoding unit can decode the length-fixed vector to an inverse sequence of an action sequence of the second agent. In other words, it is possible to inverse an order in the first action sequence and sequentially input corresponding first index vectors to the encoding unit, and at this time, prediction by the decoding unit is performed with respect to an action sequence with an inversed order of the second action sequence. Through such processing, it is possible to introduce a short term dependency between the first action sequence and the second action sequence, so as to facilitate solution of some optimization problems.

Further, according to the embodiment of the present disclosure, in order to further improve performance, it is also possible to introduce an attention mechanism in the mapping model.

The processing 300 of training the mapping model using an action sequence ends at step S305.

Next, returning back to FIG. 2, in step S204, a judgment model is trained using the first action sequence of the first agent, wherein the judgment model is capable of judging whether a current action of an action sequence of the first agent is a last action of the action sequence.

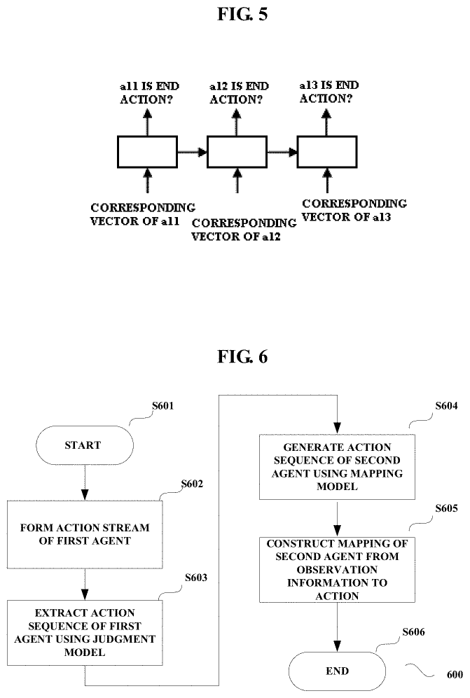

FIG. 5 shows a schematic view of exemplary processing of training a judgment model using a first action sequence.

In practical applications, an agent may continuously perform a plurality of tasks, an action sequence of a next task may start immediately after an action sequence of a previous task ends, and no explicit mark representing an end of the previous action sequence exists between the two action sequences. Therefore, a judgment model is needed to judge whether a current action of an action sequence of the first agent is a last action of the action sequence. It should be noted that, considering that the technical solution of the present disclosure is transferring processing knowledge of a trained first agent to an untrained second agent, only a first action sequence of the first agent is used to train the judgment model.

To train the judgment model, each action in the first action sequence is added with a label for determining whether the action is a last action of the first action sequence. For example, each action in the first action sequence is checked; if a subsequent action of the action is the end mark <EOS>, then the action is an end action, and the action is added with a label 1, and otherwise the action is added with a label 0, so as to construct a training sample set for training the judgment model.

According to the embodiment of the present disclosure, similarly to the encoding unit and the decoding unit of the mapping model, the judgment model can also be realized by an RNN model. Further, according to the embodiment of the present disclosure, it is also possible to use a long-short term memory (LSTM) model or a gated recurrent unit (GRU) model as an improved recurrent neural network to realize the judgment model.

Since the RNN model, the LSTM model and the GRU model are known to those skilled in the art, the present disclosure only describes applications thereof in the embodiment of the present disclosure without making detailed description of principles thereof, for the sake of conciseness.

In the training process of the judgment model, similarly to the training process of the mapping model, each action in the first action sequence as the training sample set of the judgment model is represented by a first index vector as a length-fixed vector.

As shown in FIG. 5, in the training process of the judgment model, in each time step, an input of the judgment model is a hidden state of the judgment model in a previous time step and a first index vector of a current action in the first action sequence, and an output of the judgment model is a value representing a probability of the action to be an end action and a hidden state in the current time step.

A loss function for the training of the judgment model is constructed as

$$L = \frac{1}{N} {( Y - {Y}^{′} )}^{2} .$$

Wherein Y represents a label indicating whether the current action is an end action; as stated above, if the current action is the end action, the label is 1, and otherwise the label is 0. Y′ is a result of prediction by the judgment model. N is the sum of numbers of actions included in all the first action sequences. The judgment model is trained by minimizing the loss function in each time of iterative process.

Through a plurality of times of iterations, it is possible to obtain the respective parameters of the judgment model, wherein a number of the times of the iterations may either be determined according to a convergence situation or be artificially set. For example, in a case where the LSTM model is used to realize the judgment model, it is possible to obtain, through training (iterations), numerical values of the connection weight matrixes and the biasing vectors of the LSTM model which realizes the judgment model.

Through the above-mentioned training process, the trained judgment model is capable of determining an end action in the action sequence of the first agent.

Upon completion of the training of the mapping model and the judgment model, the second agent, for example the 6 DoF target mechanical arm, is still incapable of autonomously performing a task. Therefore, in order to enable the second agent to autonomously perform a series of actions according to observation information so as to perform an identical task, it is needed to construct a mapping library of the second agent from observation information to actions, i.e., to realize transfer of processing knowledge of the first agent with respect to the task to the second agent.

Therefore, in step S205 in FIG. 2, a mapping library of the second agent, which comprises a mapping from observation information of the second agent to an action sequence of the second agent, is constructed using the trained mapping model and the trained judgment model.

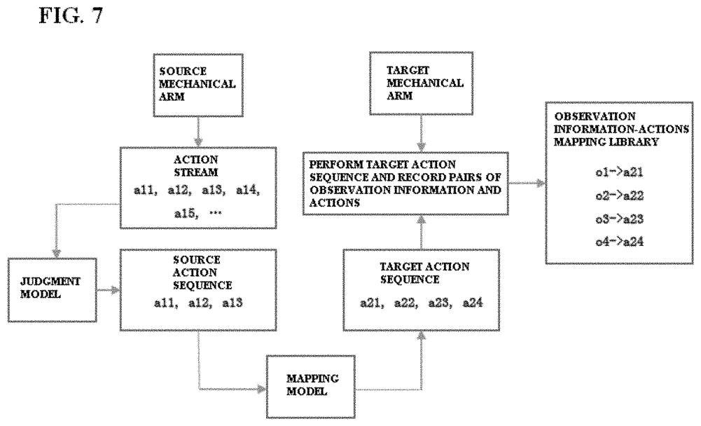

FIG. 6 shows a flowchart of exemplary processing 600 of constructing a mapping library using trained mapping model and judgment model according to an embodiment of the present disclosure. Further, FIG. 7 shows a schematic view of exemplary processing of constructing a mapping library using trained mapping model and judgment model according to an embodiment of the present disclosure.

The processing 600 starts at step S601. In step S602, the first agent performs an action stream composed of an action sequence of the first agent, according to environmental information related to the observation information of the first agent. As shown in FIG. 7, the first agent, for example the 4 DoF source mechanical arm, is a trained agent, and thus is capable of autonomously performing a series of actions according to observation information so as to perform a predetermined task, the series of actions forming an action stream a11, a12, a13, a14, a15, . . . .

The processing knowledge of the first agent referred to herein may be understood as a mapping library of the first agent from observation information to actions, and thus the trained first agent is capable of performing corresponding actions with respect to different observation information according to the mapping library so as to perform a predetermined task. The technical solution of the present disclosure may be understood as constructing a mapping library of an untrained second agent based on a mapping library of a trained first agent, so as to realize transfer of processing knowledge of the first agent to the second agent. However, since action spaces of the first agent and the second agent are different, it is needed to realize conversion between actions of the first agent and actions of the second agent using the above-mentioned mapping model and judgment model.

Therefore, subsequently in step S603, the action sequence of the first agent is extracted from the action stream using the trained judgment model. As stated above, since no end mark exists in the action stream of the first agent, it is needed to find an end action in the action stream using the trained judgment model, thereby making it possible to divide the action stream of the first agent into an action sequence of the first agent, so as to perform subsequent processing. As shown in FIG. 7, the judgment model judges in the action stream that a13 is an end action, and thus actions from a previous end action to a13 are extracted as an action sequence [a11, a12, a13] of the first agent.

Subsequently, in step S604, an action sequence of the second agent is generated according to the extracted action sequence of the first agent using the trained mapping model. As shown in FIG. 7, the mapping model can generate an action sequence [a21, a22, a23, a24] of the second agent based on the action sequence [a11, a12, a13] of the first agent.

Subsequently, in step S605, a mapping from observation information of the second agent to an action sequence of the second agent is constructed. Specifically, according to the embodiment of the present disclosure, as shown in FIG. 7, it is possible to, in the execution process of the above step S604, record observation information o1, o2, o3, o4 of the second agent before performing each action in the action sequence [a21, a22, a23, a24], and then record the observation information and the obtained actions of the second agent in pairs, such as o1->a21, o2->a22, o3->a23, o4->a24, in the mapping library of the second agent.

The above process is repeated, so as to make it possible to construct a mapping library of the untrained second agent based on the mapping library of the trained first agent, so as to realize transfer of processing knowledge of the first agent to the second agent.

The processing 600 of constructing a mapping library using trained mapping model and judgment model ends at step S606.

Through the above processing, processing knowledge of the first agent can be transferred to the second agent, such that the second agent is capable of performing corresponding actions according to observation information so as to perform an identical task. However, since the mapping library of the second agent is constructed based on the mapping library of the first agent, the second agent only has processing knowledge identical to the first agent. In other words, for observation information never encountered by the first agent, the second agent does not have corresponding processing knowledge. Therefore, in order to further improve the processing performance of the second agent, according to the embodiment of the present disclosure, it is possible to use the constructed mapping library of the second agent from observation information to actions as a training sample set to train the second agent, such that the second agent is capable of coping with observation information never encountered by the first agent previously.

The information processing method according to the present disclosure is capable of transferring processing knowledge of a trained agent with respect to a task to an untrained agent having a different action space, thereby simplifying a training process of the untrained agent having a different action space, so as to lower a training cost and improve training efficiency.

Further, the present disclosure further proposes an information processing device for transferring processing knowledge of a first agent to a second agent, wherein the first agent is capable of performing a corresponding action sequence according to observation information of the first agent.

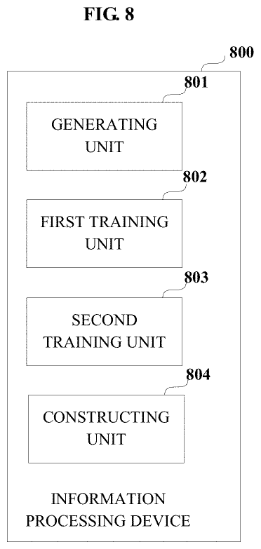

FIG. 8 shows a structural block diagram of an information processing device 800 according to an embodiment of the present disclosure. As shown in FIG. 8, the device 800 comprises a generating unit 801, which generates an action sequence pair of a first action sequence of the first agent and a second action sequence of the second agent, wherein the first action sequence and the second action sequence perform an identical task. For example, the generating unit 801 is capable of performing the processing in step S202 in the method 200 as stated above.

Further, the device 800 further comprises a first training unit 802, which trains a mapping model using the generated action sequence pair, wherein the mapping model is capable of generating an action sequence of the second agent according to an action sequence of the first agent. For example, the first training unit 802 is capable of performing the processing in step S203 in the method 200 as stated above.

Further, the device 800 further comprises a second training unit 803, which trains a judgment model using the first action sequence of the first agent, wherein the judgment model is capable of judging whether a current action of an action sequence of the first agent is a last action of the action sequence. For example, the second training unit 803 is capable of performing the processing in step S204 in the method 200 as stated above.

Further, the device 800 further comprises a constructing unit 804, which constructs a mapping library using the trained mapping model and the trained judgment model, wherein the mapping library comprises a mapping from observation information of the second agent to an action sequence of the second agent. For example, the constructing unit 804 is capable of performing the processing in step S205 in the method 200 as stated above.

Although the embodiments of the present disclosure have been described above by taking mechanical arms as a specific example of agents, the present disclosure is not limited hereto. Those skilled in the art should appreciate that, the present disclosure can be applied to any other agent having an execution mechanism than the mechanical arms, such as a robot, an unmanned car, an unmanned aerial vehicle and the like.

Further, although the embodiments of the present disclosure have been described above by only taking joint angles of mechanical arms as an example for the sake of conciseness, the present disclosure is not limited hereto. Those skilled in the art should appreciate that, besides the joint angles of the mechanical arms, the actions of the agents as disclosed herein may also relate to collapsing lengths of connecting rods and the like. In other examples of agents, for example in unmanned cars, actions of the agents may also relate to a press-down amount and a press-down stroke of a brake pedal and/or an accelerator pedal, a turning angle of a steering wheel, etc. All the above-mentioned contents should be covered within the scope of the present disclosure.

Further, although the detailed embodiments of the present disclosure have been described above based on a first agent as a 4 DoF mechanical arm and a second agent as a 6 DoF mechanical arm, those skilled in the art are capable of envisage, under the teaching of the present disclosure, other examples of the first agent and the second agent, as long as the first agent and the second agent have different action spaces but are capable of performing an identical task.

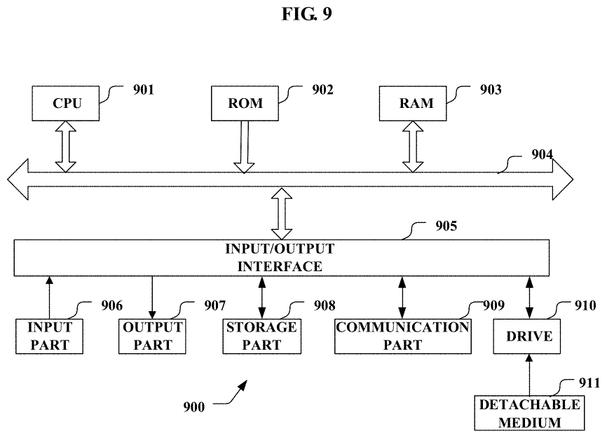

FIG. 9 shows a structure diagram of a general-purpose machine 900 that can be used to realize the information processing method and information processing device according to the embodiments of the present disclosure. The general-purpose machine 900 may be, for example, a computer system. It should be noted that, the general-purpose machine 900 is only an example, but does not suggest a limitation to a use range or function of the method and device according to the present disclosure. Also, the general-purpose machine 900 should not be construed as having a dependency or demand for any assembly or a combination thereof as shown in the above-mentioned device or method.

In FIG. 9, a Central Processing Unit (CPU) 901 executes various processing according to programs stored in a Read-Only Memory (ROM) 902 or programs loaded from a storage part 908 to a Random Access Memory (RAM) 903. In the RAM 903, data needed when the CPU 901 executes various processing and the like is also stored according to requirements. The CPU 901, the ROM 902 and the RAM 903 are connected to each other via a bus 909. An input/output interface 905 is also connected to the bus 904.

The following components are connected to the input/output interface 905: an input part 906, including a keyboard, a mouse and the like; an output part 907, including a display, such as a Cathode Ray Tube (CRT), a Liquid Crystal Display (LCD) and the like, as well as a speaker and the like; the storage part 908, including a hard disc and the like; and a communication part 909, including a network interface card such as an LAN card, a modem and the like. The communication part 909 executes communication processing via a network such as the Internet. According to requirements, a driver 910 is also connected to the input/output interface 905. A detachable medium 911 such as a magnetic disc, an optical disc, a magnetic optical disc, a semiconductor memory and the like is installed on the driver 910 according to requirements, such that computer programs read therefrom are installed in the storage part 908 according to requirements.

In a case where the foregoing series of processing is implemented by software, programs constituting the software are installed from a network such as the Internet or a storage medium such as the detachable medium 911.

Those skilled in the art should understand that, such a storage medium is not limited to the detachable medium 911 in which programs are stored and which are distributed separately from an apparatus to provide the programs to users as shown in FIG. 9. Examples of the detachable medium 911 include a magnetic disc (including a floppy disc (registered trademark)), a compact disc (including a Compact Disc Read-Only Memory (CD-ROM) and a Digital Versatile Disc (DVD), a magneto optical disc (including a Mini Disc (MD) (registered trademark)), and a semiconductor memory. Alternatively, the memory medium may be hard discs included in the ROM 902 and the memory part 908, in which programs are stored and which are distributed together with the apparatus containing them to users.

Further, the present disclosure also proposes a program product having stored thereon a machine readable instruction code that, when read and executed by a machine, can implement the above-mentioned information processing method according to the present disclosure. Accordingly, the above-listed various storage media for carrying such a program product are also included within the scope of the present disclosure.

Detailed description has been made above by means of block diagrams, flowcharts and/or embodiments, setting forth the detailed embodiments of the apparatuses and/or method according to the embodiments of the present disclosure. When these block diagrams, flowcharts and/or embodiments include one or more functions and/or operations, those skilled in the art would appreciate that the respective functions and/or operations in these block diagrams, flowcharts and/or embodiments could be separately and/or jointly implemented by means of various hardware, software, firmware or any substantive combination thereof. In one embodiment, several portions of the subject matter described in the present specification could be realized by an Application Specific Integrated Circuit (ASIC), a Field Programmable Gate Array (FPGA), a Digital Signal Processor (DSP) or other integrated forms. However, those skilled in the art would recognize that, some aspects of the embodiments described in the present specification could be equivalently implemented wholly or partially in the form of one or more computer programs running on one or more computers (e.g., in the form of one or more computer programs running on one or more computer systems), in the form of one or more programs running on one or more processors (e.g., in the form of one or more programs running on one or more micro-processors), in the form of firmware, or in the form of any substantive combination thereof moreover, according to the contents of the disclosure in the present specification, designing circuitry for the present disclosure and/or writing a code for the software and/or firmware of the present disclosure are completely within the ability of those skilled in the art.

It should be emphasized that, the term “comprise/include” used herein refers to presence of features, elements, steps or assemblies, but does not preclude presence of one or more other features, elements, steps or assemblies. The terms “first”, “second” and the like relating to ordinal numbers do not represent implementation orders or importance degrees of the features, elements, steps or assemblies defined by these terms, but are only used for performing identification among these features, elements, steps or assemblies for the sake of clarity of description.

In conclusion, in the embodiments of the present disclosure, the present disclosure provides the following solutions, but is not limited hereto:

Solution 1. An information processing method for transferring processing knowledge of a first agent to a second agent, wherein the first agent is capable of performing a corresponding action sequence according to observation information of the first agent, the information processing method comprising steps of:

generating an action sequence pair of a first action sequence of the first agent and a second action sequence of the second agent, wherein the first action sequence and the second action sequence perform an identical task;

training a mapping model using the generated action sequence pair, wherein the mapping model is capable of generating an action sequence of the second agent according to an action sequence of the first agent;

training a judgment model using the first action sequence of the first agent, wherein the judgment model is capable of judging whether a current action of an action sequence of the first agent is a last action of the action sequence; and constructing a mapping library using the trained mapping model and the trained judgment model, wherein the mapping library comprises a mapping from observation information of the second agent to an action sequence of the second agent.

Solution 2. The information processing method according to Solution 1, wherein the first agent and the second agent are mechanical arms.

Solution 3. The information processing method according to Solution 1 or 2, wherein a degree of freedom of an action of the first agent is different from a degree of freedom of an action of the second agent.

Solution 4. The information processing method according to any one of Solutions 1 to 3, wherein the action sequence pairs which are different are constructed by using different tasks.

Solution 5. The information processing method according to any one of Solutions 1 to 4, wherein the step of training the mapping model using the action sequence pair further comprises:

setting a first index of an action of the first agent, to represent the first action sequence of the first agent by a first index vector representing the first index;

setting a second index of an action of the second agent, to represent the second action sequence of the second agent by a second index vector representing the second index; and

training the mapping model using the first index vector and the second index vector.

Solution 6. The information processing method according to any one of Solutions 1 to 4, wherein the step of training the judgment model using the first action sequence further comprises:

setting a first index of an action of the first agent, to represent the first action sequence of the first agent by a first index vector representing the first index; and

training the judgment model using the first index vector.

Solution 7. The information processing method according to any one of Solutions 1 to 4, wherein

the mapping model comprises an encoding unit and a decoding unit,

the encoding unit is configured to encode an action sequence of the first agent to a length-fixed vector, and

the decoding unit is configured to decode the length-fixed vector to an action sequence of the second agent.

Solution 8. The information processing method according to any one of Solutions 1 to 4, wherein

the mapping model comprises an encoding unit and a decoding unit,

the encoding unit is configured to encode an inverse sequence of an action sequence of the first agent to a length-fixed vector, and

the decoding unit is configured to decode the length-fixed vector to an inverse sequence of an action sequence of the second agent.

Solution 9. The information processing method according to Solution 7, wherein the encoding unit and the decoding unit are realized through a recurrent neural network model.

Solution 10. The information processing method according to any one of Solutions 1 to 4, wherein the judgment model is realized through a recurrent neural network model.

Solution 11. The information processing method according to Solution 10 or 11, wherein the recurrent neural network model is a long-short term memory model or a gated recurrent unit model.

Solution 12. The information processing method according to any one of Solutions 1 to 4, wherein the step of constructing the mapping library using the trained mapping model and the trained judgment model further comprises:

performing, by the first agent, an action stream composed of an action sequence of the first agent, according to environmental information related to the observation information of the first agent;

extracting the action sequence of the first agent from the action stream using the trained judgment model;

generating an action sequence of the second agent according to the extracted action sequence of the first agent using the trained mapping model; and

constructing a mapping from observation information of the second agent to an action sequence of the second agent.

Solution 13. The information processing method according to any one of Solutions 1 to 4, further comprising:

training the second agent using the mapping library.

Solution 14. An information processing device for transferring processing knowledge of a first agent to a second agent, wherein the first agent is capable of performing a corresponding action sequence according to observation information of the first agent, the information processing device comprising:

a generating unit configured to generate an action sequence pair of a first action sequence of the first agent and a second action sequence of the second agent, wherein the first action sequence and the second action sequence perform an identical task;

a first training unit configured to train a mapping model using the generated action sequence pair, wherein the mapping model is capable of generating an action sequence of the second agent according to an action sequence of the first agent;

a second training unit configured to train a judgment model using the first action sequence of the first agent, wherein the judgment model is capable of judging whether a current action of an action sequence of the first agent is a last action of the action sequence; and

a constructing unit configured to construct a mapping library using the trained mapping model and the trained judgment model, wherein the mapping library comprises a mapping from observation information of the second agent to an action sequence of the second agent.

Solution 15. The information processing device according to Solution 14, wherein the first agent and the second agent are mechanical arms.

Solution 16. The information processing device according to Solution 14 or 15, wherein a degree of freedom of an action of the first agent is different from a degree of freedom of an action of the second agent.

Solution 17. The information processing device according to any one of Solutions 14 to 16, wherein the action sequence pairs which are different are constructed by using different tasks.

Solution 18. The information processing device according to any one of Solutions 14 to 17, wherein the first training unit is further configured to:

set a first index of an action of the first agent, to represent the first action sequence of the first agent by a first index vector representing the first index;

set a second index of an action of the second agent, to represent the second action sequence of the second agent by a second index vector representing the second index; and

train the mapping model using the first index vector and the second index vector.

Solution 19. The information processing device according to any one of Solutions 14 to 17, wherein the second training unit is further configured to:

set a first index of an action of the first agent, to represent the first action sequence of the first agent by a first index vector representing the first index; and

train the judgment model using the first index vector.

Solution 20. A computer readable storage medium having stored thereon a computer program that, when executed by a computer, implements the information processing method according to any one of Solutions 1 to 13.

Although the present disclosure has been disclosed above by describing the detailed embodiments of the present disclosure, it should be understood that those skilled in the art could carry out various modifications, improvements or equivalents for the present disclosure within the spirit and scope of the appended claims. Such modifications, improvements or equivalents should also be regarded as being included within the scope of protection of the present disclosure.

1. An information processing method for transferring processing knowledge of a first agent to a second agent, wherein the first agent is capable of performing a corresponding action sequence according to observation information of the first agent, the information processing method comprising steps of:
generating an action sequence pair of a first action sequence of the first agent and a second action sequence of the second agent, wherein the first action sequence and the second action sequence perform an identical task;
training a mapping model using the generated action sequence pair, wherein the mapping model is capable of generating an action sequence of the second agent according to an action sequence of the first agent;
training a judgment model using the first action sequence of the first agent, wherein the judgment model is capable of judging whether a current action of an action sequence of the first agent is a last action of the action sequence; and
constructing a mapping library using the trained mapping model and the trained judgment model, wherein the mapping library comprises a mapping from observation information of the second agent to an action sequence of the second agent.

2. The information processing method according to claim 1, wherein a degree of freedom of an action of the first agent is different from a degree of freedom of an action of the second agent.

3. The information processing method according to claim 1, wherein the action sequence pairs which are different are constructed by using different tasks.

4. The information processing method according to claim 1, wherein the step of training the mapping model using the action sequence pair further comprises:
setting a first index of an action of the first agent, to represent the first action sequence of the first agent by a first index vector representing the first index;
setting a second index of an action of the second agent, to represent the second action sequence of the second agent by a second index vector representing the second index; and
training the mapping model using the first index vector and the second index vector.

5. The information processing method according to claim 1, wherein the step of training the judgment model using the first action sequence further comprises:
setting a first index of an action of the first agent, to represent the first action sequence of the first agent by a first index vector representing the first index; and
training the judgment model using the first index vector.

6. The information processing method according to claim 1, wherein
the mapping model comprises an encoding unit and a decoding unit,
the encoding unit is configured to encode an action sequence of the first agent to a length-fixed vector, and
the decoding unit is configured to decode the length-fixed vector to an action sequence of the second agent.

7. The information processing method according to claim 1, wherein
the mapping model comprises an encoding unit and a decoding unit,
the encoding unit is configured to encode an inverse sequence of an action sequence of the first agent to a length-fixed vector, and
the decoding unit is configured to decode the length-fixed vector to an inverse sequence of an action sequence of the second agent.

8. The information processing method according to claim 1, wherein the step of constructing the mapping library using the trained mapping model and the trained judgment model further comprises:
performing, by the first agent, an action stream composed of an action sequence of the first agent, according to environmental information related to the observation information of the first agent;
extracting the action sequence of the first agent from the action stream using the trained judgment model;
generating an action sequence of the second agent according to the extracted action sequence of the first agent using the trained mapping model; and
constructing a mapping from observation information of the second agent to an action sequence of the second agent.

9. The information processing method according to claim 1, further comprising:
training the second agent using the mapping library.

10. An information processing device for transferring processing knowledge of a first agent to a second agent, wherein the first agent is capable of performing a corresponding action sequence according to observation information of the first agent, the information processing device comprising:
a generating unit configured to generate an action sequence pair of a first action sequence of the first agent and a second action sequence of the second agent, wherein the first action sequence and the second action sequence perform an identical task;
a first training unit configured to train a mapping model using the generated action sequence pair, wherein the mapping model is capable of generating an action sequence of the second agent according to an action sequence of the first agent;
a second training unit configured to train a judgment model using the first action sequence of the first agent, wherein the judgment model is capable of judging whether a current action of an action sequence of the first agent is a last action of the action sequence; and
a constructing unit configured to construct a mapping library using the trained mapping model and the trained judgment model, wherein the mapping library comprises a mapping from observation information of the second agent to an action sequence of the second agent.
